(19) United States
(12) Patent Application Publication
(10) Pub. No.: US 2010/0071860 A1
(43) Pub. Date: Mar. 25, 2010

(54) CREPE WADDING, METHOD FOR MANUFACTURING CREPE WADDING, FUNCTIONAL MULCHING TEXTILE

(76) Inventor: Sung Bo KIM, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/267,866

(22) Filed: Nov. 10, 2008

(30) Foreign Application Priority Data
Sep. 19, 2008 (KR) 2008-92087

(51) Int. Cl. D21C 5/02; B31F 1/12

(52) U.S. Cl. 162/5; 162/4; 162/111

(57) ABSTRACT

The present invention relates to crepe wadding and a method for manufacturing the crepe wadding wherein after waste cotton products are collected to produce cotton fiber material dried and recycled therefrom, the cotton fiber material is mixed to a pulp fiber material obtained from pulp or recycled paper and the mixture is matured, thereby making the crepe wadding, and to a functional mulching textile having the crepe wadding wherein the crepe wadding is laminated to another crepe wadding or a cotton non-woven fabric and a variety of functional materials are charged into the space formed between the laminated sheets, thereby preventing water and soil from being polluted during the manufacturing and further being utilized in various fields including mulching and environment-friendly organic agriculture according to the kinds of the functional materials charged during the laminating process.

### BACKGROUND OF THE INVENTION

1. Field of the Invention

The present invention relates to crepe wadding, a method for manufacturing the crepe wadding, and a functional mulching textile having the crepe wadding, and more particularly, to crepe wadding and a method for manufacturing the crepe wadding wherein after waste cotton products are collected to produce cotton fiber material dried and recycled therefrom, the cotton fiber material is mixed to a pulp fiber material obtained from pulp or recycled paper and the mixture is matured, thereby making the crepe wadding, and to a functional mulching textile having the crepe wadding wherein the crepe wadding is laminated to another crepe wadding or a cotton non-woven fabric and a variety of functional materials are charged into the space formed between the laminated sheets, thereby preventing water and soil from being polluted during the manufacturing and further being utilized in various fields including mulching and environment-friendly organic agriculture according to the kinds of the functional materials charged during the laminating process.

2. Background of the Related Art

So as to cultivate agricultural products, a mulching film is generally used to cover the soil to be cultivated, thereby achieving the moisture retention in the soil, adjusting the earth temperature, suppressing the growth of weeds, preventing the generation of the contagious bacteria in the soil, and keeping the soil pollution. Conventional mulching textiles are made of polyethylene or polyvinyl chloride. With the increasing interest in the environmental pollution and safe food products over the world, recently, organic agricultural products become popular because they are produced with relatively small amount of agricultural chemicals or chemical fertilizers. As the economic level of people becomes high, this popularity of the organic agricultural products is more increased, and also, domestic agricultural policies have been varied depending upon agricultural products cultivated by a variety of methods according to the import liberalization of international agricultural products.

Since the mulching textile made of the synthetic resin polymer should be one by one collected after the use, high personnel costs are needed, and also, since complete collection is not achieved in a manual operation, soil pollution is happened. Therefore, there is a need for the improvement of the agricultural mulching textile as one of the agricultural policies.

According to the investigation of Korean resource recycling department in 2003, it is estimated that an amount of yearly waste vinyl is about 261 tons, but an amount of waste vinyl collected is about 151 tons, which is just 58% of the amount of waste vinyl. Actually, the waste vinyl of 110 tons is not collected. Since a considerate quantity of waste vinyl which is not collected is used again as the mulching film in a cultivated area, the national treasury of about 2.5 billion won is paid as the expenses for collecting the waste vinyl so as to effectively collect waste vinyl and waste farming materials. Thus, the period for collecting the waste vinyl and the waste farming materials is separately fixed.

So as to solve the above-mentioned problems, there is disclosed Korean Paten Application Laid-Open No. 10-2005-37646 entitled ‘Mulching paper for agriculture and method for manufacturing the same’, but the mulching paper has a high cost and a relatively thick thickness, such that since it has a relatively high weight and needs a separate rice transplanter, it is difficult to use the mulching paper in case of farmhouses having poor finance. Further, Korean Patent Registration Nos. 0723921 and 0691795 disclose mulching paper that contains environment-friendly elements and is naturally degraded and agricultural mulching textile that is made of pulp or a non-woven fabric. However, since the mulching textile does not have the functions required according to the multiple variations of environmental conditions of agriculture, it has a limitation in use. Moreover, since a wet fibrillation process is needed in the recycling of waste products, waste water is discharged to cause serious environmental pollution problems.

### SUMMARY OF THE INVENTION

Accordingly, the present invention has been made in view of the above-mentioned problems occurring in the prior art, and it is an object of the present invention to provide an object of the present invention to provide crepe wadding and a method for manufacturing crepe wadding wherein since the crepe wadding is manufactured by using waste cotton products, the waste cotton products can be positively recycled, while previously preventing the water pollution due to the waste water generated during the recycling of the waste cotton products, thereby achieving environmental protection and producing the crepe wadding at a substantially low cost through the recycling of the waste cotton products.

It is another object of the present invention to provide a functional mulching textile having crepe wadding which is manufactured by processing the crepe wadding, thereby having better air ventilation, tensile strength, moisture retention, and warmth keeping properties when compared with existing mulching textiles, and which is biodegraded after a predetermined period of time has passed, thereby causing no secondary environmental pollution.

It is yet another object of the present invention to provide a functional mulching textile having crepe wadding which is capable of filling functional materials needed according to the area where the functional mulching textile is used and the purposes of the use thereof into a buffering space formed upon the lamination of crepe wadding sheets, thereby being multipurposely utilized according to the functions and purposes of the functional materials charged therein.

To accomplish the above objects, according to the present invention, there is provided a method for manufacturing crepe wadding including the steps of: conducting a waste cotton product fibrillation process wherein after metals are separated from collected waste cotton products, the waste cotton products are cut off to a predetermined size and the cut waste cotton products are fibrillated by means of a dry cutting device, thereby making a cotton fiber material; conducting a pulp and recycled paper fibrillation process wherein pulp and recycled paper are cut off and fibrillated, thereby making a pulp fiber material; conducting a mixing and maturing process wherein the cotton fiber material made by the waste cotton products and the pulp fiber material made by the pulp and recycled paper are mixed to each other and matured in a storage tank; and conducting a crepe wadding producing process wherein the mixed and matured fiber materials in the mixing and maturing process have crepes formed by means of a crepe wadding producing device and are dried after the formation of the crepes, thereby producing the crepe wadding.

According to the present invention, preferably, the waste cotton products are cut off to a size of 10 cm×10 cm during a first cutting process, and the waste cotton products are cut off to a size of 3 cm to 5 cm×3 cm to 5 cm during a second cutting process, which allows the cotton fibrillation to be easily achieved.

On the other hand, in the mixing and maturing process it is desirable that 60% to 70% by weight of cotton fibers and 30% to 40% by weight of pulp fibers are mixed to each other, and the mixing rate can be varied according to the purposes and functions of the product. Moreover, in the mixing and maturing process it is desirable that the mixture is matured at a temperature in a range of 25° C. to 30° C. for two to three hours. The above temperature and reaction conditions are determined according to the use and purpose of the crepe wadding.

According to the method for manufacturing the crepe wadding, on the other hand, the biodegradation-fertilizing material serving to fertilize the biodegradation of the fibers is added in the mixing and maturing process, so as to enhance the biodegradation performance of the crepe wadding and prevent the secondary soil pollution.

The biodegradation-fertilizing material used at this time is formed of one or more selected from protein, carbonhydrate, and a biodegradation-fertilizing enzyme, and an amount of the biodegradation-fertilizing material is determined according to the environmental characteristics in a place where the crepe wadding is used and the biodegradation speed. On the other hand, the biodegradation-fertilizing enzyme is formed of one or more selected from protease, amylase, and lipase, and the biodegradation-fertilizing enzyme is fed with protein or carbonhydrate like starch.

Moreover, the crepe wadding of the present invention is made according to the method for manufacturing the crepe wadding of the present invention.

According to the functional mulching textile having the crepe wadding, the crepe wadding is laminated to another crepe wadding or a cotton non-woven fabric, thereby forming a buffering space between the laminated crepe wadding to each other or between the laminated crepe wadding and the cotton non-woven fabric. Therefore, the functional mulching textile has more excellent air ventilation than existing one-fold vinyl and also has higher tensile strength and folding endurance since it is formed of two folds. On the other hand, the cotton non-woven fabric is made of the waste cotton generated in cotton spinning industries and low grade of cotton fabrics.

Furthermore, since the biodegradation-fertilizing material is contained in the crepe wadding forming the mulching textile, there is no need for separately collecting and removing the mulching textile after the use. That is, the mulching textile is naturally biodegraded and mixed to the soil after a predetermined period of time has passed, thereby preventing the secondary environmental pollution of the soil. Further, the formation of the buffering space between the crepe wadding laminated to each other provides a more excellent warmth keeping property than the existing one-fold mulching textile, and also, the functional material having functions needed according to the purposes of the functional mulching textile of the present invention is charged into the buffering space. In more detail, the emulsionized functional material is charged into the buffering space formed by the lamination and is compressed and dried, thereby manufacturing the functional mulching textile according to the present invention, such that the functionality of the mulching textile can be strengthened. On the other hand, the functional material used at this time is desirably formed of a mixture mixed with one or more selected from a biodegradation-fertilizing enzyme, charcoal powder, yellow ocher, carbonhydrate, inorganic powder containing minerals, and a liquid biofertilizer.

At this time, the biodegradation-fertilizing enzyme serves to enhance the biodegradation capability of the functional mulching textile of the present invention, the charcoal powder serves to enhance an air ventilating capability and a soil purification capability as it is charged into the buffering space, and the yellow ocher serves to enhance a warmth keeping capability of the mulching textile by the emission of the far infrared rays therefrom. On the other hand, the carbonhydrate is added together with the biodegradation-fertilizing enzyme to serve to activate the biodegradation-fertilizing enzyme for fertilizing the biodegradation process, and the inorganic powder containing minerals serves to allow various minerals to be permeated into the soil as the functional mulching textile is gradually biodegraded, thereby enriching the soil. Moreover, if it is desired to enrich the soil, the liquid biofertilizer is also added, such that the capsules by respective fertilizer components are degraded to have slow release characteristics. Thus, after the mulching textile is used it is biodegraded such that the fertilizer components are slowly permeated into the soil, which makes the slow release of the fertilizer more strengthened when compared with the fertilizer directly supplied in the soil.

On the other hand, the inorganic powder containing minerals is pulverized to 300 mesh size to 350 mesh size, which ensures the permeability to the soil and the easiness of the filling into the buffering space, and also, when a variety of functional materials are emulsionized, the pulverization of the inorganic powder to the above mesh size is desirable to conduct the emulsionizing with ease.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a flowchart showing the processes for manufacturing crepe wadding and a functional mulching textile according to the present invention;

FIGS. 2a to 2d are detailed flowcharts showing the processes for manufacturing crepe wadding and a functional mulching textile according to the present invention, wherein FIG. 2a shows the fibrillation process of waste cotton products, FIG. 2b shows the fibrillation process of pulp and recycled paper, FIG. 2c shows the production of the crepe wadding, and FIG. 2d shows the process for manufacturing the functional mulching textile using the crepe wadding; and

FIGS. 3a and 3b are sectional views showing a functional mulching textile according to the present invention, wherein FIG. 3a shows the structure of the functional mulching textile formed by laminating the crepe wadding to each other, and FIG. 3b shows the structure of the functional mulching textile formed by laminating the crepe wadding to a cotton non-woven fabric.

### DETAILED DESCRIPTION OF THE PREFERRED EMBODIMENT

Hereinafter, an explanation on a method for manufacturing the crepe wadding and a functional mulching textile with the crepe wadding contained therein according to the present invention will be given with reference to the attached drawings.

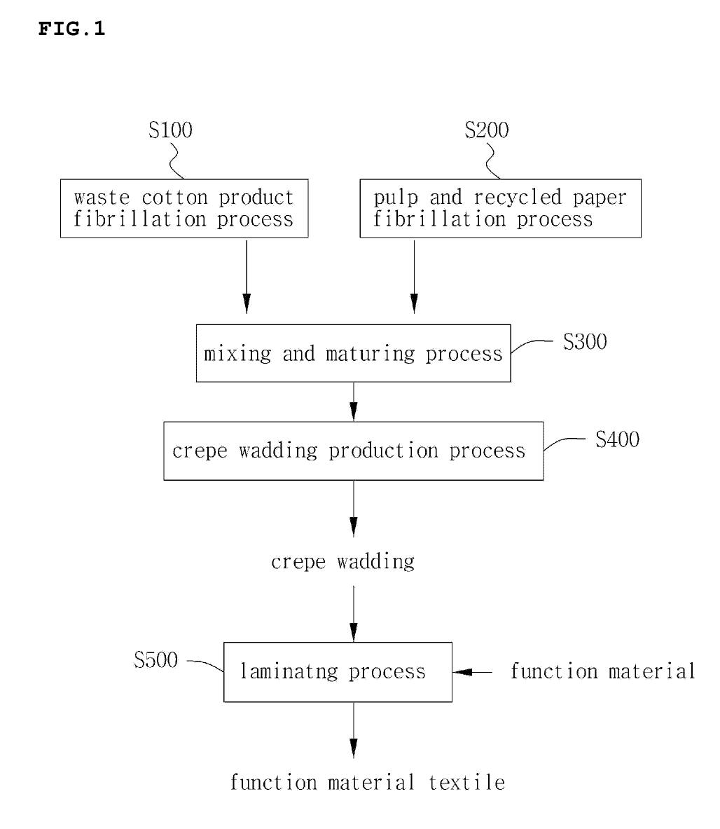

FIG. 1 is a flowchart showing the processes for manufacturing crepe wadding and a functional mulching textile according to the present invention.

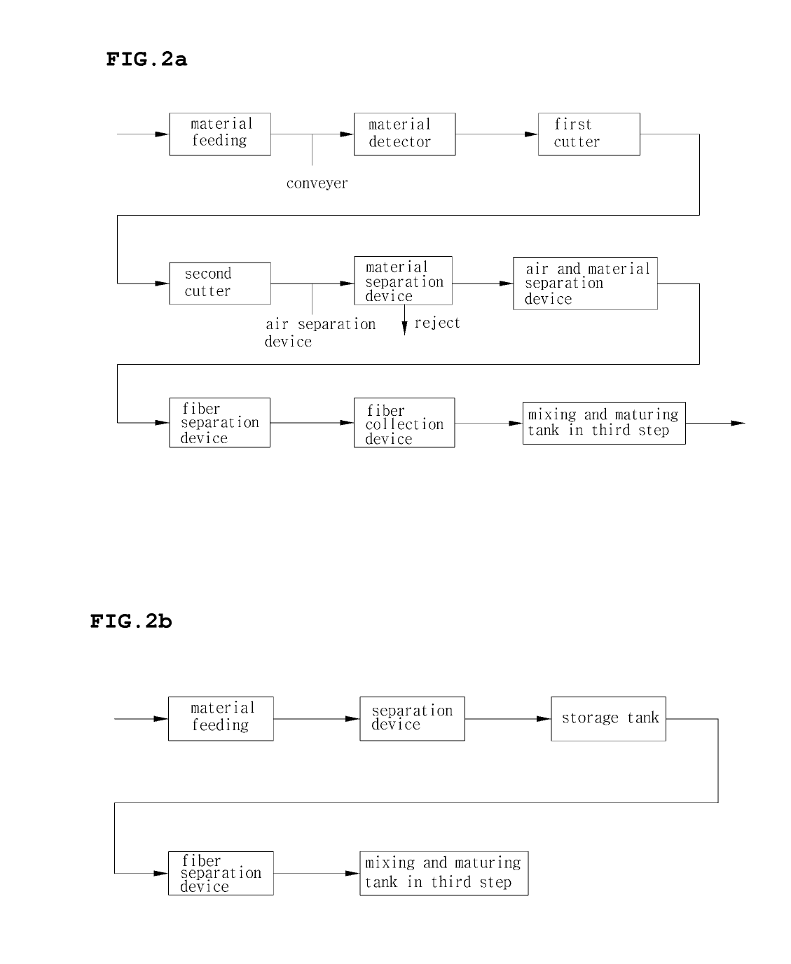

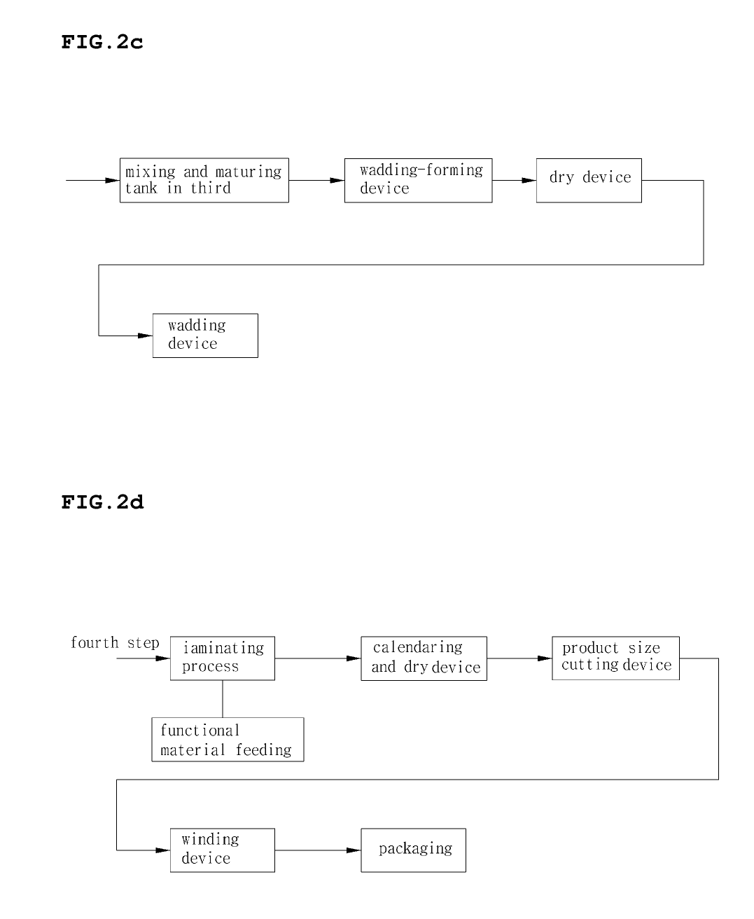

FIGS. 2a to 2d are detailed flowcharts showing the processes for manufacturing crepe wadding and a functional mulching textile according to the present invention, wherein FIG. 2a shows a fibrillation process S100 of waste cotton products, FIG. 2b shows a fibrillation process S200 of pulp and recycled paper, FIG. 2c shows the production of the crepe wadding, and FIG. 2d shows the process for manufacturing the functional mulching textile using the crepe wadding

In the fibrillation process S100 of waste cotton products, the waste generated in cotton processing companies, castoff clothes, and the waste generated during the manufacturing of cotton products are recycled to fibers. During this process, no water is used, and the cotton fibers are recycled by using air flow by means of a dry process.

An explanation on the fibrillation process S100 of the waste cotton products will be in detail given with reference to FIG. 2a. First, the waste cotton products are put as a raw material and are conveyed by a feed conveyor, and during the conveying, metallic foreign materials are isolated from the waste cotton products by using a metal detector. After that, the waste cotton products are cut off to a size of 10 cm×10 cm by means of a first cutter during a first cutting process, and next, they are conveyed through an air duct for a second cutting process. In the second cutting process, the waste cotton products are cut off to a size of 3 cm to 5 cm×3 cm to 5 cm by means of a second cutter. The cut waste cotton products through the second cutter are cut off finely by means of a mill using a rotary centrifugal force like a grinding stone, which becomes the cotton fibers. After that, air is separated from the cotton fibers through an air separation device, and only the cotton fibers remain through an air and material separation device and a fiber separation device. The isolated cotton fibers are collected to a fiber collection device and are then conveyed to a mixing and maturing tank.

In the fibrillation process S200 of pulp and recycled paper, cellulose tissues are separated through a dry process from the pulp and the recycled paper as general textile making materials, which become fibers. Next, the fibers are conveyed to the mixing and maturing tank. In other words, as shown in FIG. 2b, the pulp and recycled paper materials are put to separate the cellulose tissues therefrom. Next, the pulp and recycled paper are stored in a storage tank, and pulp fibers are made through a fiber separation device and are then conveyed to the mixing and maturing tank.

In a mixing and maturing process S300, the cotton fibers recycled in the fibrillation process S100 of the waste cotton products and the pulp fibers recycled in the fibrillation process S200 of pulp and recycled paper are mixed and matured in the mixing and maturing process. At this time, a mixing rate between the cotton fibers and the pulp fibers is determined so as to adjust the tensile strength and the folding endurance according to the environment of an area to which the crepe wadding is used and according to the purpose and function of the crepe wadding, and an amount of addition of protein, carbonhydrate, and a biodegradation-fertilizing enzyme as a material for fertilizing biodegradation and their maturing time are determined so as to adjust the biodegraded speed of the product.

The mixed material after the mixing and maturing process S300 is produced as the crepe wadding through a crepe wadding production process S400, and the crepe wadding is formed of smooth wadding like crepe paper. When the crepes are enlarged, the curved surfaces are formed up and down. If the length of the crepe wadding is 1 m, desirably, it is extended to a length between 1.5 m and 2 m when unfolded. In this case, the surface area of the crepe wadding that is contacted with the equal area thereto becomes large, thereby enhancing the moisture retention and absorption capabilities.

When the crepe wadding is produced in the above-mentioned manner, the functional mulching textile can be manufactured by laminating the crepe wadding and another crepe wadding to each other or by laminating the crepe wadding and the cotton non-woven fabric to each other, by producing the two-fold mulching textile, by filling the emulsionized functional material needed for the purposes of the mulching textile into the buffering space formed by the lamination, and by compressing and drying the mulching textile.

An explanation on the process of producing the crepe wadding will be in detail given with reference to FIG. 2c. In the production process of the crepe wadding, the material processed in the mixing and maturing tank is made as the crepe wadding by means of a wadding-forming device, and at this time, it is desirable that the wadding-forming device should include a compression roller having a protrusion part having up and down irregular surfaces along the outer periphery thereof. First, after the crepes on the mixed material are formed through the wadding-forming device, the crepe wadding is dried by means of a dry device and is wound by a winding roller of a winding device. Next, the wound crepe wadding is stored at a predetermined place.

The crepe wadding may be laminated with another crepe wadding or a cotton non-woven fabric through a laminating process S500, thereby producing the functional mulching textile. In practical production, the functional mulching textile should be desirably made to a length in a range of 500 m to 700 m per minute and to a width of at least 2 m, which can be used for multi-purposes.

FIG. 2d shows the process for manufacturing the functional mulching textile using the crepe wadding, wherein the crepe wadding is laminated to another crepe wadding or the cotton non-woven fabric to form a two-fold mulching textile. At this time, a functional material may be added to the laminating process, if necessary. After that, the functional mulching textile is dried by means of calendaring and a dry device, and next, it is cut off to a needed product size by means of a cutting device. Then, the functional mulching textile is wound and packaged, thereby completing the manufacturing of the functional mulching textile.

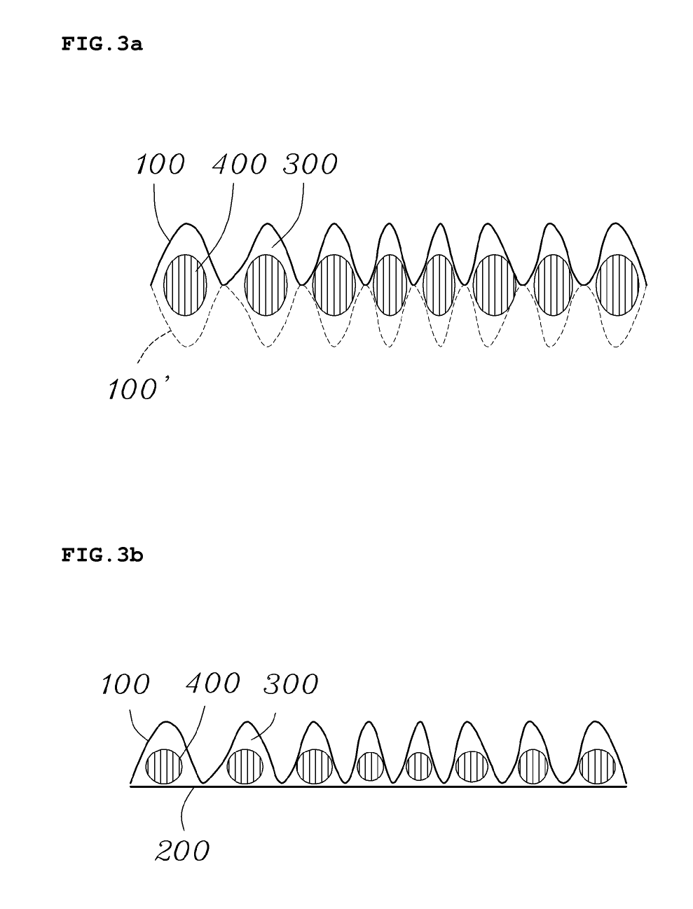

FIGS. 3a and 3b are sectional views showing the functional mulching textile according to the present invention, wherein FIG. 3a shows the structure of the functional mulching textile formed by laminating the crepe wadding to each other, and FIG. 3b shows the structure of the functional mulching textile formed by laminating the crepe wadding to the cotton non-woven fabric.

As shown in FIG. 3a, the crepe wadding 100 and another crepe wadding 100′ are laminated to each other, thereby forming the two-fold mulching textile, and at this time, the valley of one side crepe wadding should meet the peak of the other side crepe wadding to be laminated at the upper or lower side of one side crepe wadding, which forms a buffering space 300 in which a functional material 400 is charged between the crepe wadding laminated to each other. First, the functional material 400 is emulsionized, and next, the filling is carried out together with the laminating process. The functional material 400, which is needed according to the characteristics of an agricultural product and the mulching textile product, is applied to the buffering space 300.

As shown in FIG. 3b, the crepe wadding 100 and the cotton non-woven fabric 200 are laminated to each other, thereby forming the mulching textile, and at this time, the buffering space 300 is formed between the crepe wadding 100 and the cotton non-woven fabric 200. Even though the two-fold mulching textile manufactured by laminating the crepe wadding 100 and the cotton non-woven fabric 200 does not have any separate functional material in the buffering space 300, it has better air ventilation and warmth keeping properties when compared with existing mulching textiles. In addition, since the two-fold mulching textile can be naturally biodegraded and have strong textile strength, it can be positively utilized as a warmth keeping coating material for agriculture. Of course, if the functional material 400 is charged into the buffering space 300, the two-fold mulching textile is utilized as a functional mulching textile.

Referring to the use example of the functional mulching textile according to the present invention, the functional mulching textile can be first used for dry field agriculture, and at this time, it functions to suppress the growth of the weeds, provide good air ventilation to conduct gentle oxygen supply to the soil, and provide good water absorption such that when it rains, rainwater is sufficiently transmitted to the soil, thereby maintaining the moisture and temperature adequate to the growth of the agricultural product. Moreover, the functional mulching textile functions to help the root of the agricultural product well grow, thereby leading the healthy growth of the agricultural product and increasing an amount of reaping of the agricultural products.

On the other hand, the functional mulching textile can be used for wet field agriculture, and at this time, if it is attached to a rice transplanter and is applied on a wet field during the rice transplanting, no weeds grow, such that no weed killer is used to achieve the rice production in an organic agricultural manner and to previously prevent the water and soil pollution caused by agricultural chemicals. On the other hand, if the functional mulching textile is used in direct seeding, the personnel costs can be reduced.

Furthermore, if the agricultural mulching textile is used having the functional material needed for the agricultural product charged thereinto, it contains the nutrition facts and necessary components required for the growth of the agricultural product and is also biodegraded naturally to serve as a fertilizer, which sufficiently provides a function as a slow release fertilizer and a function of previously preventing soil acidification through the addition of the nutrition supply of the soil environment and the mineral components.

As mentioned above, according to the crepe wadding and the method for manufacturing the crepe wadding of the present invention, when the waste cotton products and the pulp or the recycled paper are fibrillated, firstly, they are processed in a dry fibrillation manner, without using any water, thereby preventing the waste water generated during a wet fibrillation manner and further preventing the environmental pollution due to the waste water. Secondly, the biodegradation-fertilizing material is added to the crepe wadding manufactured by the method of the present invention, thereby increasing a biodegradation efficiency, such that even though the crepe wadding is separately collected and removed after the use, it can be naturally biodegraded in the soil after a predetermined period of time, thereby previously preventing the environmental pollution of the soil, and the waste products as the material of the fibrillation are recycled, thereby having low production costs and providing economical crepe wadding.

According to the functional mulching textile having the crepe wadding of the present invention, moreover, the crepe wadding is laminated to another crepe wadding or the cotton non-woven fabric, thereby forming the buffering space at the inside thereof, such that the functional mulching textile has more excellent air ventilation, folding endurance, tensile strength, moisture retention, absorption rate, and warmth keeping property when compared with the existing mulching textile made of one-fold vinyl.

According to the functional mulching textile having the crepe wadding of the present invention, on the other hand, the emulsionized functional material, which is adequate to the environment where the mulching textile is used and to the purpose of the mulching textile, is charged into the buffering space and is utilized for a variety of purposes thereof. Further, the biodegradation-fertilizing enzyme is charged into the buffering space, irrespective of the biodegradation-fertilizing material contained in the crepe wadding, such that the mulching textile is rapidly biodegraded after the use, thereby preventing the soil pollution.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method for manufacturing crepe wadding comprising the steps of:
conducting a waste cotton product fibrillation process wherein after metals are separated from collected waste cotton products, the waste cotton products are cut off to a predetermined size and the cut waste cotton products are fibrillated by means of a dry cutting device, thereby making a cotton fiber material;
conducting a pulp and recycled paper fibrillation process wherein pulp and recycled paper are cut off and fibrillated, thereby making a pulp fiber material;
conducting a mixing and maturing process wherein the cotton fiber material made by the waste cotton products and the pulp fiber material made by the pulp and recycled paper are mixed to each other and matured in a storage tank; and
conducting a crepe wadding producing process wherein the mixed and matured fiber materials in the mixing and maturing process have crepes formed by means of a crepe wadding producing device and are dried after the formation of the crepes, thereby producing the crepe wadding.

2. The method for manufacturing crepe wadding according to claim 1, wherein the waste cotton products are cut off to a size of 10 cm×10 cm during a first cutting process, and the waste cotton products are cut off to a size of 3 cm to 5 cm×3 cm to 5 cm during a second cutting process.

3. The method for manufacturing crepe wadding according to claim 1, wherein in the mixing and maturing process 60% to 70% by weight of cotton fibers and 30% to 40% by weight of pulp fibers are mixed to each other.

4. The method for manufacturing crepe wadding according to claim 1, wherein in the mixing and maturing process the mixture is matured at a temperature in a range of 25° C. to 30° C. for two to three hours.

5. The method for manufacturing crepe wadding according to claim 1, wherein in the mixing and maturing process a biodegradation-fertilizing material serving to fertilize the biodegradation of the fibers is added.

6. The method for manufacturing crepe wadding according to claim 5, wherein the biodegradation-fertilizing material is formed of one or more selected from protein, carbonhydrate, and a biodegradation-fertilizing enzyme.

7. The method for manufacturing crepe wadding according to claim 6, wherein the biodegradation-fertilizing enzyme is formed of one or more selected from protease, amylase, and lipase.

8. Crepe wadding manufactured by the method for manufacturing the crepe wadding according to claim 1.

9. A functional mulching textile comprising:
a first crepe wadding sheet disposed at one side surface thereof; and
a second crepe wadding sheet or a cotton non-woven fabric disposed at the other side surface thereof in such a manner as to be laminated to the first crepe wadding sheet, thereby forming a buffering space between the first crepe wadding sheet and the second crepe wadding sheet or the cotton non-woven fabric.

10. The functional mulching textile according to claim 9, wherein the buffering space is charged with an emulsionized functional material and is compressed and dried.

11. The functional mulching textile according to claim 10, wherein the functional material is formed of a mixture mixed with one or more selected from a biodegradation-fertilizing enzyme, charcoal powder, yellow ocher, carbonhydrate, inorganic powder containing minerals, and a liquid biofertilizer.

12. The functional mulching textile according to claim 11, wherein the inorganic powder containing minerals is pulverized to 300 mesh size to 350 mesh size.

13. Crepe wadding manufactured by the method for manufacturing the crepe wadding according to claim 2.

14. Crepe wadding manufactured by the method for manufacturing the crepe wadding according to claim 3.

15. Crepe wadding manufactured by the method for manufacturing the crepe wadding according to claim 4.

16. Crepe wadding manufactured by the method for manufacturing the crepe wadding according to claim 5.

17. Crepe wadding manufactured by the method for manufacturing the crepe wadding according to claim 6.

18. Crepe wadding manufactured by the method for manufacturing the crepe wadding according to claim 7.
